(19) United States
(12) Patent Application Publication
(10) Pub. No.: US 2012/0269152 A1
(43) Pub. Date: Oct. 25, 2012

(54) METHOD FOR CONFIGURING A RESOURCE, METHOD FOR TRANSCEIVING DATA IN THE CONFIGURED RESOURCE, AND APPARATUS FOR SAME IN A WIRELESS COMMUNICATION SYSTEM

(75) Inventors: Sungkwon Hong, Seoul (KR); Kibum Kwon, Ansan-si (KR); Kitae Kim, Suwon-si (KR); Kyoungmin Park, Goyang-si (KR)

(73) Assignee: PANTECH CO., LTD., Seoul (KR)

(21) Appl. No.: 13/515,662

(22) PCT Filed: Dec. 7, 2010
(86) PCT No.: PCT/KR10/08687

§ 371 Date: Jun. 13, 2012

(30) Foreign Application Priority Data
Dec. 15, 2009 (KR) 10-2009-0124442
Dec. 6, 2010 (KR) 10-2010-0123240

(51) Int. Cl. H04W 72/04

(52) U.S. Cl. 370/329

(57) ABSTRACT

The present description relates to a wireless communication system, a method for configuring a resource, a method for transceiving data in the configured resource, and an apparatus for the same. The method described in the present description comprises: selecting one or more resource block groups from among the resource block groups contained in at least one or more component carriers so as to generate an aggregated resource block group; and allocating resources in accordance with the configuration of the aggregated resource block group, and transceiving data. Here, information on the aggregated resource block group contains a component carrier indicator.

### CROSS-REFERENCE TO RELATED APPLICATIONS

This application is the National Stage Entry of International Application No. PCT/KR2010/008687, filed on Dec. 7, 2010, and claims priority from and the benefit under 35U.S.C. §119(a) of Korean Patent Application No. 10-2009-0124442, filed on Dec. 15, 2009 and Korean Patent Application No. 10-2010-0123240, filed on Dec. 6, 2010, which to are hereby incorporated by reference for all purposes as if fully set forth herein.

### BACKGROUND

1. Field

The present invention relates to a wireless communication system, and more particularly to a method for configuring resources, and a method and apparatus for transmitting/receiving data through the configured resources.

2. Discussion of the Background

Due to an increase in a bandwidth which can be used in a wireless communication system including a user equipment and a base station or due to the use of multiple component carriers, a problem occurs in that the decoding complexity of a downlink control channel increases.

### SUMMARY

Therefore, the present invention provides a method and apparatus for aggregating resource block groups included in one or more component carriers in a wireless communication system.

Also, the present invention provides a method for configuring resources by aggregating resource blocks included in one or more component carriers, a method for transmitting/receiving data through the configured resources, and a user equipment and a base station using the same in a wireless communication system.

Also, the present invention provides a method and an apparatus, which can efficiently configure resources by aggregating resource block groups of one or more component carriers in a configuration for aggregating component carriers in a wireless communication system.

Also, the present invention provides a method and apparatus for configuring resources, which can simply realize backward compatibility in a configuration for aggregating component carriers in a wireless communication system.

Also, the present invention provides a method and apparatus for configuring resources, which enable a simple configuration of a control channel for aggregating component carriers in a wireless communication system.

Also, the present invention provides a method and apparatus for configuring resources, which can reduce blind decoding complexity of a user equipment for decoding a downlink control channel.

In order to accomplish the above-mentioned objects, in accordance with an aspect of the present invention, there is provided a method for transmitting/receiving data according to configuring of radio resources by a base station in a wireless communication system. The method includes: selecting one or more resource block groups (RBGs) from among RBGs included in one or more component carriers, and generating a set of resource block groups (SRBG); transmitting information on configuring of the generated SRBG to a user equipment; and allocating a resource to the user equipment according to configuring of the SRBG, and transmitting/receiving data to/from the user equipment through the allocated resource, wherein the information on configuring of the SRBG includes a component carrier indicator.

In accordance with another aspect of the present invention, there is provided a method for transmitting/receiving data through radio resources by a user equipment in a wireless communication system. The method includes: receiving information on configuring of a set of resource block groups (SRBG) from a base station; receiving a resource allocated by the base station according to configuring of the SRBG; and transmitting/receiving data to/from the base station through one or more resources within the SRBG, wherein the information on configuring of the SRBG includes a component carrier indicator.

In accordance with still another aspect of the present invention, there is provided a base station apparatus for transmitting/receiving data according to configuring of radio resources in a wireless communication system. The base station apparatus includes: an SRBG generator for selecting one or more RBGs from among RBGs included in one or more component carriers, and generating a set of resource block groups (SRBG); a resource allocator for allocating a resource to a user equipment according to configuring of the SRBG; and a transmitter/receiver for transmitting information on configuring of the generated SRBG to the user equipment, and transmitting/receiving data to/from the user equipment through the resource allocated by the resource allocator, wherein the information on configuring of the SRBG includes a component carrier indicator.

In accordance with yet another aspect of the present invention, there is provided a user equipment for transmitting/receiving data through radio resources in a wireless communication system. The user equipment includes: a transmitter/receiver for receiving is information on configuring of an SRBG from a base station, and transmitting/receiving data to/from the base station; an SRBG information storage unit for storing the information on configuring of the SRBG, which has been received from the base station; and a controller for controlling the transmitter/receiver so as to transmit/receive data through a resource allocated based on the information on configuring of the SRBG, wherein the information on configuring of the SRBG includes a component carrier indicator.

As described above, according to an embodiment of the present invention, there is an effect such that resources can be efficiently configured by aggregating resource block groups of one or more component carriers in a configuration for aggregating carriers in a wireless communication system.

Also, according to an embodiment of the present invention, there is an effect such that backward compatibility can be simply realized in a configuration for aggregating carriers in a wireless communication system. Also, according to an embodiment of the present invention, there is an effect of enabling a simple configuration of a control channel for aggregating carriers in a wireless communication system. Also, according to an embodiment of the present invention, there is an effect such that it is possible to reduce blind decoding complexity of a user equipment for decoding a downlink control channel.

### BRIEF DESCRIPTION OF THE DRAWINGS

FIG. 1 is a view schematically showing a wireless communication system providing a method for configuring resources according to an embodiment of the present invention.

FIG. 2 is a view showing carrier aggregation of one or more component carriers used in a wireless communication system in order to provide a method for configuring resources according to an embodiment of the present invention.

FIG. 3 is a view showing the configuration of an SRBG (Set of Resource Block Groups) for a method for configuring resources according to an embodiment of the present invention.

FIG. 4 is a flowchart showing the operation of a base station for a method for configuring resources through configuring of an SRBG in downlink in a method for configuring resources according to an embodiment of the present invention.

FIG. 5 is a flowchart showing the operation of a user equipment for a method for configuring resources through configuring of an SRBG in downlink in a method for configuring resources according to an embodiment of the present invention.

FIG. 6 is a flowchart showing the operation of a base station for a method for configuring resources through configuring of an SRBG in uplink in a method for configuring resources according to an embodiment of the present invention.

FIG. 7 is a flowchart showing the operation of a user equipment for a method is for configuring resources through configuring of an SRBG in uplink in a method for configuring resources according to an embodiment of the present invention.

FIG. 8 is a view showing an example of number assignment when an SRBG is configured according to an embodiment of the present invention.

FIG. 9 is a view showing another example of number assignment when an SRBG is configured according to an embodiment of the present invention.

FIG. 10 is a view showing an independent HARQ operation for each component carrier, which is related to configuring of an SRBG, according to an embodiment of the present invention.

FIG. 11 is a view showing an example of configuring an SRBG in configuring a compatible carrier and an extension carrier in configuring an SRBG according to an embodiment of the present invention.

FIG. 12 is a view showing the configuration of a base station for generating an SRBG and transmitting/receiving data to/from a user equipment according to an embodiment of the present invention.

FIG. 13 is a view showing the configuration of a user equipment which is allocated a resource based on an SRBG and transmits/receives data to/from a base station through the allocated resource, according to an embodiment of the present invention.

### DETAILED DESCRIPTION OF THE ILLUSTRATED EMBODIMENTS

Hereinafter, exemplary embodiments of the present invention will be described in detail with reference to the accompanying drawings. It should be noted that in assigning reference numerals to elements in the drawings, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be understood that if it is described in the specification that one component is “connected,” “coupled” or “joined” to another component, a third component may be “connected,” “coupled,” and “joined” between the first and second components, although the first component may be directly connected, coupled or joined to the second component.

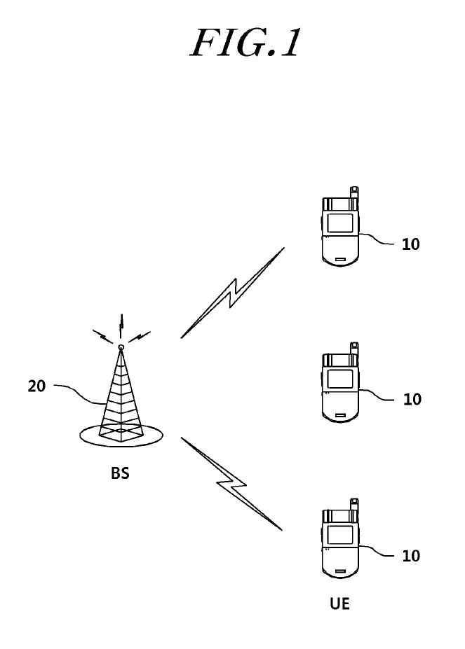

FIG. 1 is a view schematically showing a wireless communication system providing a method for configuring resources according to an embodiment of the present invention. In the present invention, the wireless communication system is a system for providing various communication services, such as voice, packet data, etc.

Referring to FIG. 1, the wireless communication system includes a User Equipment (UE) 10 and a Base Station (BS) (20).

In the present invention, the User Equipment (UE) 10 has a comprehensive concept implying a user terminal in wireless communication. Accordingly, the UEs should be interpreted as having the concept of including an MS (Mobile Station), a UT (User Terminal), an SS (Subscriber Station), a wireless device, and the like in GSM (Global System for Mobile Communications) as well as UEs (User Equipments) in WCDMA (Wideband Code Division Multiple Access), LTE (Long Term Evolution), HSPA (High Speed Packet Access), etc.

The base station 20 or a cell usually refers to a fixed station communicating with the user equipment 10, and may be called different terms, such as a Node-B, an eNB (evolved Node-B), a BTS (Base Transceiver System), and an AP (Access Point). Hereinafter, the base station 20 is denoted as eNB.

In the present invention, the eNB 20 or the cell should be interpreted as having to a comprehensive meaning indicating a partial area covered by a BS (Base Station) in CDMA (Code Division Multiple Access) or a Node-B in WCDMA (Wideband Code Division Multiple Access). Accordingly, the base station 20 or the cell has a meaning including various coverage areas such as a mega cell, a macro cell, a micro cell, a pico cell, and a femto cell.

The user equipment 10 and the eNB 20, which are two (uplink or downlink) is transmission and reception subjects used to implement the art or the technical idea described in the present invention, are used as a comprehensive meaning, and are not limited by a particularly designated term or word. Herein, the term “uplink” refers to a scheme in which the user equipment 10 transmits/receives data to/from the eNB 20, and the term “downlink” refers to a scheme in which the eNB 20 transmits/receives data to/from the user equipment 10.

Hereinafter, the present invention is characterized in that there is no limitation on multiple access schemes applied to the wireless communication system. Namely, the present invention may be applied by using various multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, and OFDM-CDMA.

In this regard, use may be made of a TDD (Time Division Duplex) scheme in which uplink transmission and downlink transmission are performed at different times. Otherwise, use may be made of an FDD (Frequency Division Duplex) scheme in which uplink to transmission and downlink transmission are performed by using different frequencies.

An embodiment of the present invention may be applied to the allocation of resources in the field of asynchronous wireless communications which have gone through GSM, WCDMA and HSPA, and evolve into LTE (Long Term Evolution) and LTE-A (Long Term Evolution-Advanced), and in the field of synchronous wireless communications which evolve is into CDMA, CDMA-2000 and UMB. The present invention should not be interpreted as being limited to or restricted by a particular wireless communication field, and should be interpreted as including all technical fields to which the spirit of the present invention can be applied.

Meanwhile, in LTE, a specification is established by configuring uplink (UL) and downlink (DL) based on one component carrier or one component carrier pair. In uplink and downlink, control information is transmitted through a control channel, such as a PDCCH (Physical Downlink Control CHannel), a PCFICH (Physical Control Format Indicator CHannel), a PHICH (Physical Hybrid ARQ Indicator CHannel), a PUCCH (Physical Uplink Control CHannel), or the like. Also, a data channel, such as a PDSCH (Physical Downlink Shared CHannel), a PUSCH (Physical Uplink Shared CHannel), or the like, is first configured, and is then used to transmit data.

Meanwhile, in LTE, a specification regarding a single component carrier forms the basis of LTE and a combination of a couple of bandwidths, each having a bandwidth smaller than 20 MHz is discussed, whereas in LTE-A, bandwidths of component carriers, each having a bandwidth equal to or greater than 20 MHz is being discussed. In LTE-A, multi-carrier aggregation is basically discussed by considering the best backward compatibility based on the basic specification of LTE, and a maximum of five carriers are considered in uplink and downlink. An important point among the points discussed in this multi-carrier aggregation is how to configure the extension of a control channel and configure a data channel according to an increase in the number of carriers. Also, a maximum of five carriers as described above show a tendency in which the number of carriers is growing larger at the request of quality of services.

Meanwhile, in uplink and downlink, at least one carrier or at least one component carrier pair is called either an anchor carrier, a primary cell, a serving cell, or a special cell, and corresponds to a carrier which a user equipment initially accesses, through which the user equipment receives security and authentication information, and which is controlled according to subsequent multi-carrier aggregation.

In the multi-carrier aggregation, multiple points considered in relation to the design of a control channel include a point regarding the transmission of an uplink ACKnowledgement/Negative ACKnowledgement signal, and a point regarding the transmission of uplink channel information including a Channel Quality Indicator (CQI), a Precoding Matrix Indicator (PMI), and a Rank Indicator (RI). The CQI/PMI/RI information is transmitted through a PUCCH (Physical Uplink Control Channel) and a PUSCH (Physical Uplink Shared Channel) which are uplink control channels, in various schemes.

In the case of the multi-carrier aggregation in LTE-A, because the number of component carriers is plural and the amount of information transmitted through an uplink control channel is increased by approximately the number of carriers, inefficiency can occur in allocating resources by configuring an RBG (Resource Block Group) of each carrier. Particularly, in the case of the multi-carrier aggregation in LTE-A, there may exist an asymmetric situation where the number of carriers in uplink differs from the number of carriers in downlink. When the amount of information transmitted through an uplink control channel is increased by approximately the number of carriers, even greater inefficiency can occur in allocating resources by configuring an RBG of each carrier.

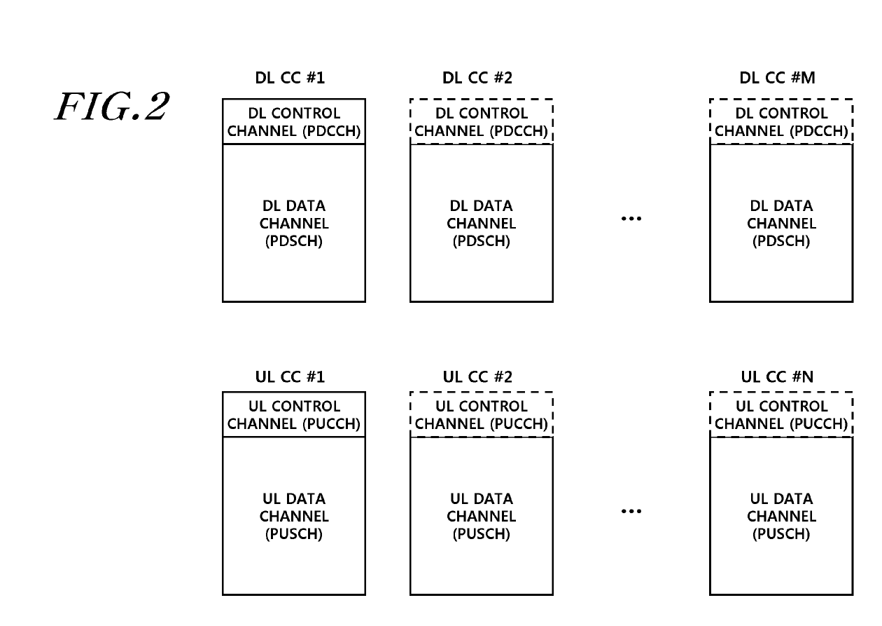

FIG. 2 is a view showing carrier aggregation of one or more component carriers used in a wireless communication system in order to provide a method for configuring resources according to an embodiment of the present invention.

Referring to FIG. 2, the wireless communication system may have a carrier aggregation configuration using one or more Component Carriers (CCs). When the wireless communication system uses an M number of downlink component carriers (DL CCs) in downlink (DL) and uses an N number of uplink component carriers (UL CCs) in uplink (UL), it may have the carrier aggregation configuration as shown in FIG. 2. At this time, there may exist an asymmetric situation where the number of component carriers in uplink differs from the number of component carriers in downlink. Namely, the value of M may differ from that of N.

Referring to FIG. 2, each of an M number of downlink component carriers has a downlink data channel for transmitting data, and each of some or all of an M number of downlink component carriers has a downlink control channel for transmitting control information. Also, each of an N number of uplink component carriers has an uplink data channel for transmitting data, and each of some or all of an N number of uplink component carriers has an uplink control channel for transmitting control information. Each of a downlink data channel and an uplink data channel may be configured based on a Resource Block Group (RBG) including one or more Resource Blocks (RBs) in a two-dimensional domain of time and frequency. Herein, the downlink control channel may be a PDCCH or the like, and the downlink data channel may be a PDSCH or the like. The uplink control channel may be a PUCCH or the like, and the uplink data channel may be a PUSCH or the like. The above configuration may be applied to all embodiments of the present invention, which will be described below.

A wireless communication system 100 according to an embodiment of the present invention configures a Set of Resource Block Groups (SRBG) by connecting RBGs existing within one or more component carriers together with the use of one or more component carriers, and performs resource allocation based on information on the configuration of the SRBG.

In this case, the SRBG may include one RBG including one or more resource blocks, or may include two or more RBGs, each including one or more resource blocks. Also, the RBG, for example, includes an RB, a Physical Resource Block (PRB) and an RBG, which are defined in 3GPP (3^{rd} Generation Partnership Project) LTE/in LTE-A, and includes resource block units in a typical two-dimensional domain of time and frequency.

Meanwhile, a data channel may be configured based on an RBG. Control is information on the allocation of the resources for each user and for each service is determined by a layer higher than a physical layer of a serving eNB, and is transmitted through a control channel and is operated.

When an SRBG includes two or more RBGs, the SRBG may be configured by connecting RBGs within a carrier or by connecting RBGs between carriers. Namely, the two or more RBGs included in the SRBG may exist within an identical component carrier and may be connected, or at least one of the two or more RBGs included in the SRBG may exist within another component carrier and may be connected to an RBG other than the at least one RBG.

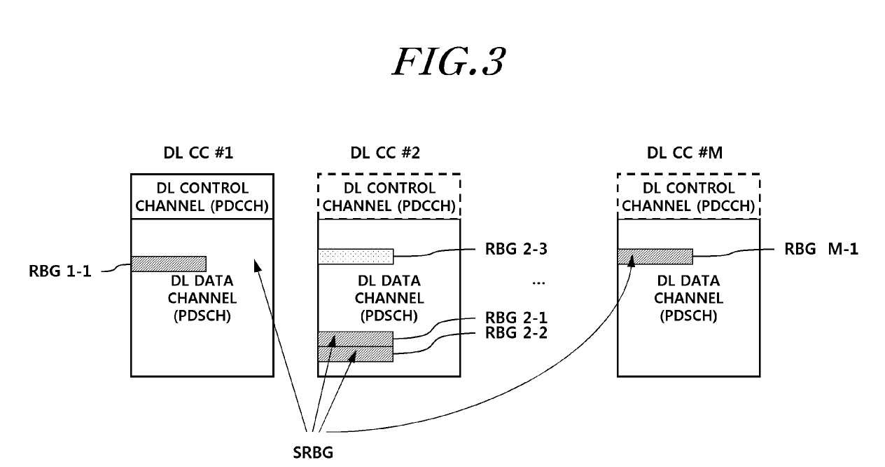

FIG. 3 is a view showing the configuration of an SRBG (Set of Resource Block Groups) for a method for configuring resources according to an embodiment of the present invention.

Referring to FIG. 3, one SRBG may be configured by connecting an RBG 1 within a downlink component carrier 1 (RBG 1-1), an RBG 1 within a downlink component carrier 2 (RBG 2-1), an RBG 2 within a downlink component carrier 2 (RBG 2-2), and an RBG 1 within a downlink component carrier M (RBG M−1). Also, referring to FIG. 3, an RBG 3 within the downlink component carrier 2 (RBG 2-3) may form one SRBG by itself, without being connected to an RBG existing within the downlink component carrier 2 or RBGs existing within downlink component carriers other than the downlink component carrier 2.

Namely, an RBG which does not form an SRBG within one component carrier is may exist. This RBG may be regarded as a special SRBG, in which the number of RBGs is equal to 1.

For carrier aggregation, the number of RBGs within each component carrier may be identical in each component carrier set. In contrast, the number of RBGs within each component carrier may have a difference in each component carrier set. Because the characteristics of a channel that each component carrier has may change according to user equipments, the aggregation of RBGs does not need to be configured in such a manner that an RBG is uniformly collected from each component carrier. Also, as an example of an RBG, all component carriers may be defined as one RBG.

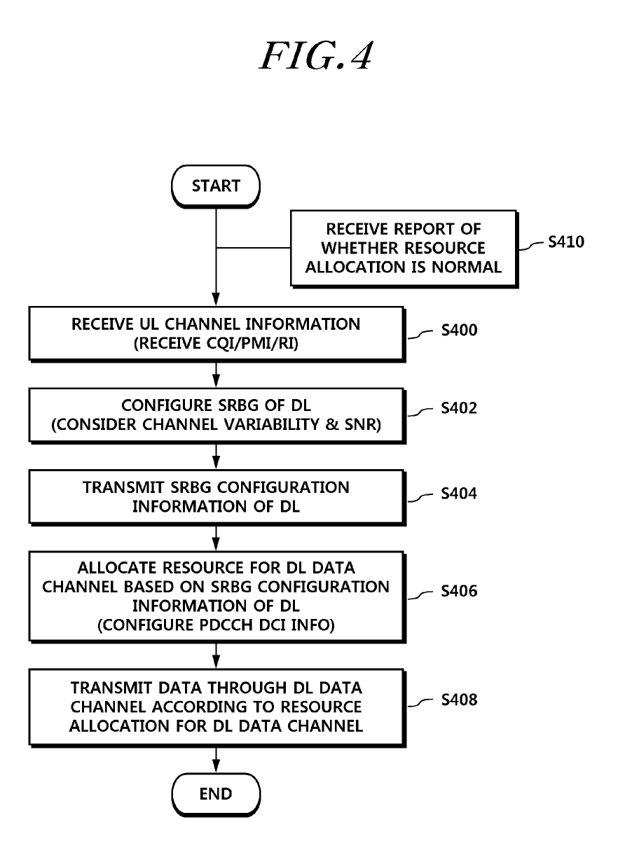

Hereinafter, what criteria are used and which RBGs are to be connected in order to configure an SRBG when the SRBG is configured, will be described in each of downlink and uplink. Also, a series of operations of the eNB 20 and the user equipment 10 in the wireless communication system 100, which include configuring of an SRBG in each of downlink and uplink, and resource allocation, transmission/reception of data and the like, which are associated with configuring of the SRBG in each of downlink and uplink, will be described with reference to FIG. 4 to FIG. 7.

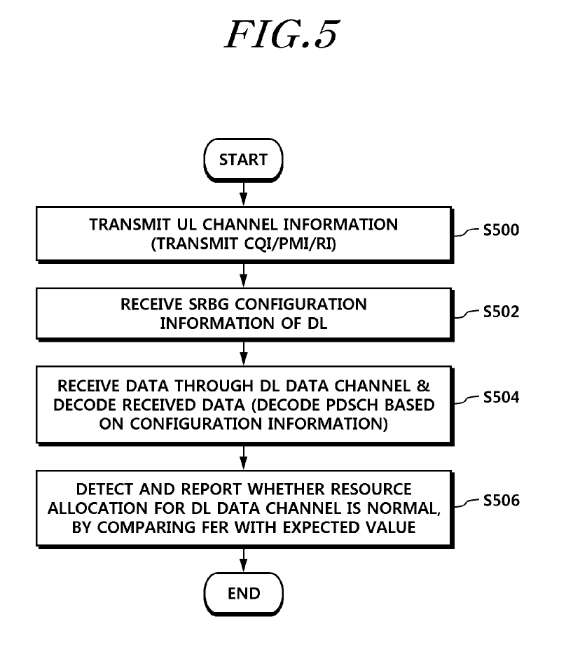

First, FIG. 4 is a flowchart showing the operation of the eNB 20, and FIG. 5 is a flowchart showing the operation of the user equipment 10. When a configured SRBG corresponds to an SRBG in downlink in the wireless communication system 100, configuring of is an SRBG in downlink, a method for configuring resources, which is associated with resource allocation and the like in downlink according to configuring of the SRBG, and transmission/reception of data through a resource allocated by the method for configuring resources, will be described below.

FIG. 4 is a flowchart showing the operation of an eNB for a method for configuring resources through of configuring an SRBG in downlink in a method for configuring resources according to an embodiment of the present invention.

Referring to FIG. 4, in order to configure an SRBG in downlink, the eNB 20 receives uplink channel information used to configure an SRBG of downlink from the user equipment 10 through an uplink control channel (e.g. PUCCH) (S400).

The eNB 20 configures an SRBG by connecting some of all RBGs existing within one or more component carriers in downlink, with reference to the variability of the received uplink channel information, the level of a Signal-to-Noise Ratio (SNR) value or that of a Modulation and Coding Scheme (MCS) value of the received uplink channel information, and the like (S402).

As an example of configuring an SRBG, the eNB 20 may receive uplink channel information, such as a CQI (Channel Quality Indicator), a PMI (Precoding Matrix Indicator), a RI (Rank Indicator) and the like, may compare the variability of and the level of the received uplink channel information, may aggregate RBGs, and may configure an SRBG. For example, an SRBG may be formed by connecting (collecting) RBGs, each of which has the variability of channel information, which is similarly slow within a certain defined range, and each of which has the level of an SNR value or that of an MCS value, which is similar within a certain defined range. As another embodiment, another SRBG may be formed by connecting (collecting) RBGs, each of which has the variability of channel information, which is similarly fast within a certain defined range, and each of which has the level of an SNR value or that of an MCS value, which is similar within a certain defined range. At this time, with additional reference to one or more information among the requirement of Quality of Service (QoS), fairness, the maximization of overall downlink capacity, the performance of downlink control channel blind decoding, and the like, the eNB 20 may configure an SRBG in downlink by connecting some of all RBGs existing within one or more component carriers in downlink.

When the SRBG in downlink has been configured, the eNB 20 transmits SRBG configuration information of downlink, to the user equipment 10 through a downlink control channel (e.g. PDCCH) (S404).

Resource allocation for a downlink data channel (e.g. PDSCH) is performed based on the SRBG configuration information of downlink (S406). At this time, information on the resource allocation for the downlink data channel (e.g. PDSCH) may be transmitted to the user equipment 10 through a downlink control channel (e.g. PDCCH).

The eNB 20 transmits data to the user equipment 10 through the downlink data is channel (e.g. PDSCH) based on resource allocation information in downlink (S408). Namely, the resource allocation in downlink is first performed in such a manner that the downlink data channel (e.g. PDSCH) is configured according to configuring of an SRBG in downlink as described above, and then data is transmitted through the downlink data channel.

Also, the eNB 20 may receive a report of whether resource allocation is normal, from the user equipment 10 (S410). In this case, the eNB 20 may proceed with reconfiguring of an SRBG in view of the report. For example, the eNB 20 may cancel the existing SRBG and may form a new SRBG, or may abandon the relevant SRBG itself. In relation to forming of a new SRBG, the eNB 20 may reconfigure all SRBGs and may perform resource allocation, in view of whether resource allocation is normal. Otherwise, the eNB 20 may reconfigure only a relevant SRBG related to abnormal resource allocation, and may perform resource allocation.

The resource allocation information, for example, may first be included in a Downlink Control Information (DCI) message, which is carried by a PDCCH and is transmitted through the PDCCH, and then the DCI message including the resource allocation information may be transmitted.

FIG. 5 is a flowchart showing the operation of a user equipment for a method for configuring resources through configuring of an SRBG in downlink in a method for configuring resources according to an embodiment of the present invention.

Referring to FIG. 5, so that the eNB 20 may configure an SRBG in downlink, the user equipment 10 measures uplink channel information corresponding to information required to configure the SRBG in downlink, and transmits the measured uplink channel information to the eNB 20 through an uplink control channel (e.g. PUCCH) (S500). Accordingly, the eNB 20 first configures the SRBG in downlink, and then transmits information on configuring of the SRBG in downlink.

Namely, the user equipment 10 receives the SRBG configuration information of downlink from the eNB 20 (S502), and decodes data received through a downlink data channel (e.g. PDSCH) based on the SRBG configuration information of downlink (S504).

The user equipment 10 compares a decoding performance value with a predefined expected value, detects whether resource allocation is normal according to configuring of an SRBG, based on a result of the comparison, and reports a result of the detection to the eNB 20 (S506). Accordingly, the eNB 20 may cancel the existing SRBG and may form a new SRBG in view of the report, or may abandon a relevant SRBG itself.

Next, when a configured SRBG corresponds to an SRBG in uplink in the wireless communication system 100 according to an embodiment of the present invention, configuring of an SRBG in uplink, a method for configuring resources, which is associated with resource allocation and the like in uplink according to configuring of the SRBG, and transmission/reception of data through a resource allocated by the method for configuring resources, will be described below.

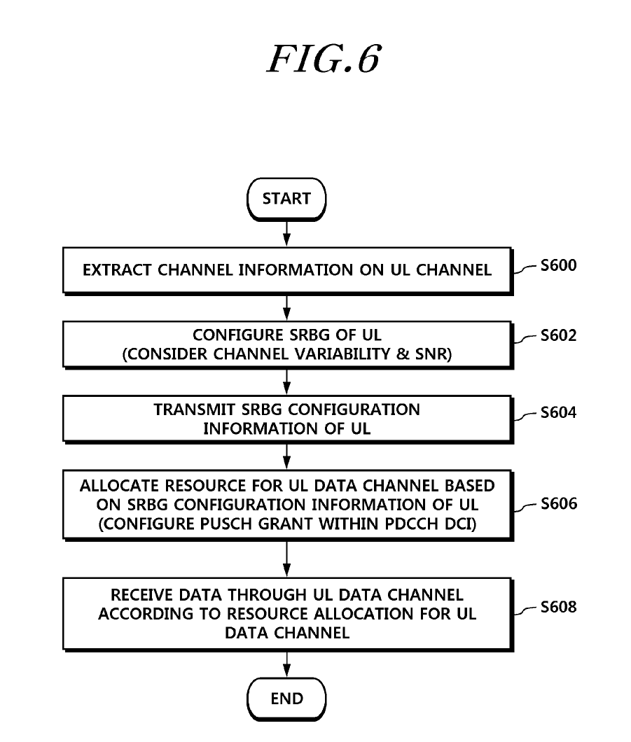

FIG. 6 is a flowchart showing the operation of an eNB for a method for configuring resources through configuring of an SRBG in uplink in a method for configuring resources according to an embodiment of the present invention.

The operation of the eNB 20 will be described with reference to FIG. 6. The eNB 20 extracts channel information from a reference signal of a data channel (e.g. PUSCH) and from a reference signal of a control channel (e.g. PUCCH), which are received in uplink (S600). The eNB 20 configures an SRBG of uplink by connecting some of all RBGs existing within one or more component carriers in uplink, with reference to the variability of the extracted channel information and the level of an SNR value or that of an MCS value of the extracted channel information (S602).

When the eNB 20 determines that due to the aggregation of RBGs in uplink, there is an advantage for grant decoding of resource allocation for an uplink data channel (e.g. PUSCH) through a downlink control channel (e.g. PDCCH) while performance degradation of the uplink data channel (e.g. PUSCH) is minimized, the eNB 20 determines the aggregation of RBGs and configures an SRBG in uplink, and transmits SRBG configuration information of uplink to the user equipment 10 (S604). Namely, when the SRBG in uplink is configured, the eNB 20 transmits the information on configuring of the SRBG configured in uplink, to the user equipment 10 through the downlink control channel (e.g. PDCCH) (S604).

Thereafter, the eNB 20 performs resource allocation for the uplink data channel (e.g. PUSCH) based on the SRBG configuration information of uplink (S606). Namely, the eNB 20 configures an uplink data channel (e.g. PUSCH) grant within downlink control channel (e.g. PDCCH) DCI. At this time, the eNB 20 may transmit information on the resource allocation for the uplink data channel (e.g. PUSCH) to the user equipment 10 through the downlink control channel (e.g. PDCCH). The eNB 20 may receive data from the user equipment 10 through the uplink data channel (e.g. PUSCH) based on the information on the resource allocation for the uplink data channel (e.g. PUSCH) (S608).

The resource allocation information as described above may first be included in a DCI message used to transmit a resource grant on the uplink data channel (e.g. PUSCH), and then the DCI message including the resource allocation information may be transmitted through the downlink control channel (e.g. PDCCH).

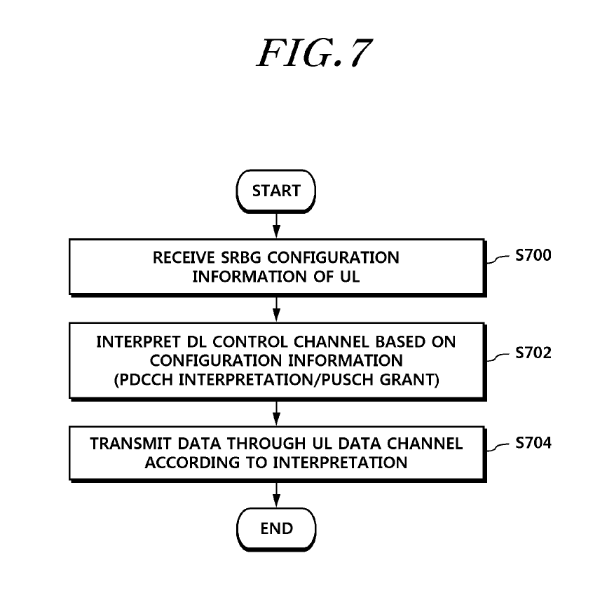

FIG. 7 is a flowchart showing the operation of a user equipment for a method for configuring resources through configuring of an SRBG in uplink in a method for configuring resources according to an embodiment of the present invention. In configuring an uplink data channel (e.g. PUSCH), the user equipment 10 may configure the uplink data channel according to the information on configuring of the SRBG in the eNB 20 as described above.

Referring to FIG. 7, the user equipment 10 receives the SRBG configuration information of uplink, which has been configured by the eNB 20, from the eNB (S700), and interprets a downlink control channel (e.g. PDCCH) based on the SRBG configuration information of uplink (S702). This interpretation includes interpreting of the resource grant transmitted through the DCI carried by the downlink control channel (e.g. PDCCH). According to a result of this interpretation, the user equipment 10 may transmit data through the uplink data channel (e.g. PUSCH) (S704).

Hereinafter, information on configuring of an SRBG according to configuring of the SRBG will be described.

Information on configuring of an SRBG may include information indicating a position of the SRBG, etc. The information indicating the position of the SRBG may include a number assigned to an SRBG by using an identical component carrier indicator, or a number assigned to an SRBG by using different component carrier indicators.

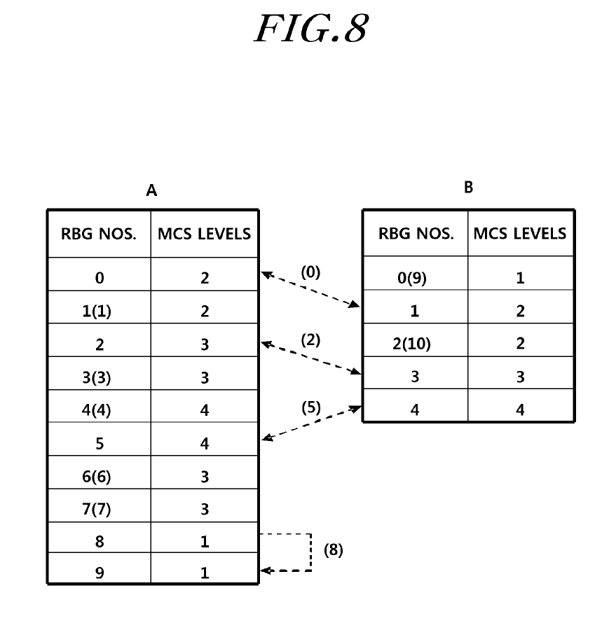

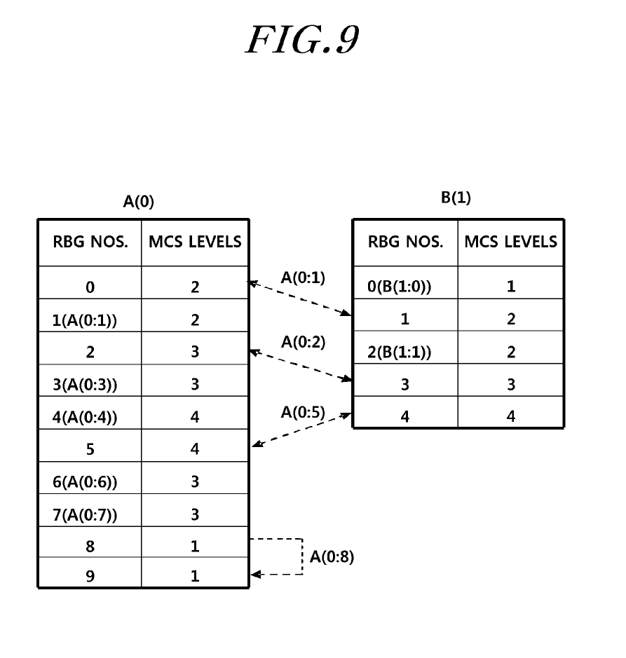

In this regard, in order to indicate a position of an SRBG, an SRBG may be assigned a number by using an identical component carrier indicator or different component carrier indicators. Hereinafter, an example of assigning numbers to SRBGs by using an to identical component carrier indicator is shown in FIG. 8, and an example of assigning numbers to SRBGs by using different component carrier indicators is shown in FIG. 9.

In relation to this assignment of a number to an SRBG, there may exist multiple methods for indicating a position of an RBG allocated within a PDCCH in a carrier. With respect to the predetermined number of RBGs, the user equipment 10 is notified of is positions of RBGs allocated in the following three schemes through a predetermined field within a DCI format of a PDCCH.

Among the above three schemes, a first scheme corresponds to a scheme in which one bit indicates an arrangement state of one RBG and a bit string having a predetermined length indicates positions of RBGs allocated among all RBGs. A second scheme corresponds to a scheme in which RBGs having a predetermined space therebetween among all RBGs are first collected and classified and then only these RBGs are used to allocate RBGs. A third scheme corresponds to a scheme for applying indexing to the number of all possible cases of RBGs from a first RBG to a last RBG within a carrier.

Even in an environment of newly configured SRBGs, schemes for reporting positions of the RBGs may be identically applied to the present invention. To this end, it is required to assign a number to each SRBG in the same form as the existing system, and two embodiments of this number assignment are shown in FIG. 8 and FIG. 9.

FIG. 8 is a view showing an example of number assignment when an SRBG is configured according to an embodiment of the present invention.

FIG. 8 shows a case of connecting a component carrier A including ten RBGs to a component carrier B including five RBGs. Based on the stability of an MCS level depending on an SNR value and an MCS value, an RBG #0, an RBG #2 and an RBG #5 within the component carrier A are connected to an RBG #1, an RBG #3 and an RBG #4 within the carrier B, respectively. Accordingly, three SRBGs such as A0-B1, A2-B3 and A5-B4 are configured. Also, an RBG #8 and an RBG #9 within the component carrier A are connected to each other, and an SRBG such as A8-A9 is configured.

As shown in FIG. 8, a case where two or more RBGs are connected is described as an example of four SRBGs including A0-B1, A2-B3, A5-B4 and A8-A9. Also, A1, A3, A4, A6, A7, B0 and B2 correspond to seven SRBGs, each configured from one RBG. These 11 SRBGs may be assigned numbers as shown in FIG. 8, respectively. Herein, ( ) represents a number of an SRBG. The number assignment as shown in FIG. 8 may be configured according to the following criteria.

Firstly, an SRBG may be assigned a number in such an order that reference is given to a component carrier which includes RBGs, the number of which is the largest, among component carriers forming an SRBG. Secondly, an SRBG may be assigned a number according to an existing number of a reference component carrier. Thirdly, an SRBG may be assigned a number in such a manner that a number is connected to another number in order with respect to a component carrier including RBGs, the number of which is smaller than the number of RBGs within another component carrier. At this time an RBG which has already been assigned a number may be excluded from number assignment.

As shown in FIG. 8, 11 SRBGs may be obtained from 15 RBGs. When an RBG is assigned a number as shown in FIG. 8, a position of the SRBG may be expressed by a method, such as an existing method for indexing resource allocation.

A method for allocating resources may be configured in such a manner as to transmit a PDCCH for each component carrier and indicate a component carrier used to allocate a resource through a DCI format of a PDCCH of the component carrier. A field indicating these directions is defined as a component carrier indicator. In allocating resources according to configuring of SRBGs under these conditions, connected component carriers may be considered as one component carrier group, and an identical component carrier indicator may be used for the connected component carriers.

Meanwhile, there may exist a scheme for assigning numbers by using different component carrier indicators instead of using an identical component carrier indicator. In this scheme, an SRBG belongs to a component carrier indicator of one component carrier selected from among relevant component carriers and is assigned a number. For SRBGs each of which is configured without being connected to another component carrier (for example, an RBG A1, an RBG A3, an RBG A4, an RBG A6 and an RBG A7 within a component carrier A, and an RBG B0 and an RBG B2 within a component carrier B), a component carrier indicator of a component carrier to which each SRBG belongs, may be used. This number assignment is shown in FIG. 9.

FIG. 9 is a view showing another example of number assignment when an SRBG is configured according to an embodiment of the present invention.

Referring to FIGS. 9, (0) and (1) at A(0) and B(1) signify component carrier indicators, respectively. SRBGs are assigned numbers with A(0) as reference. SRBGs, each of which belongs to the component carrier B and is configured from only one RBG (for example, an SRBG configured from an RBG #0 and an SRBG configured from an RBG #2, within the component carrier B), are independently assigned numbers by using (1) representing a component carrier indicator of the component carrier B.

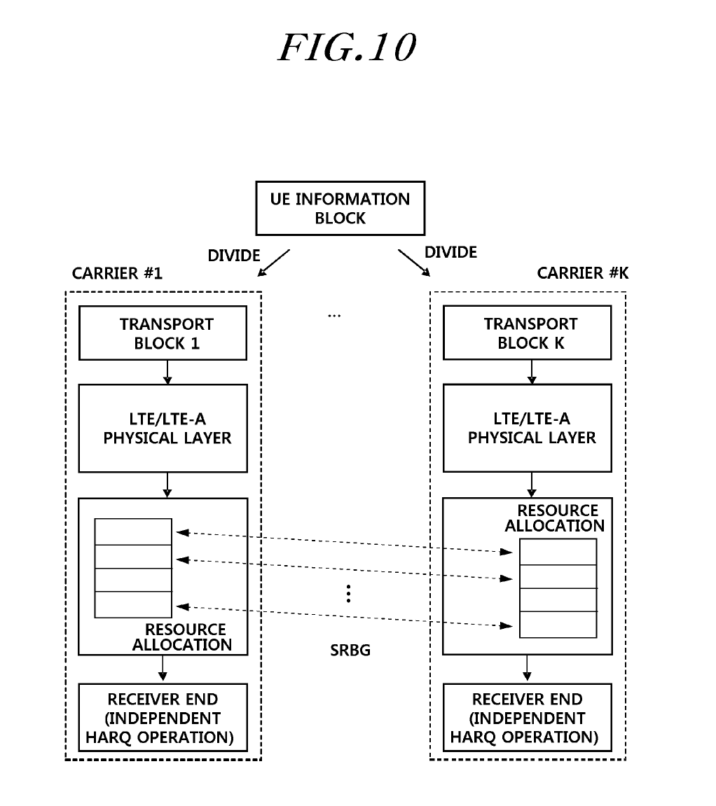

FIG. 10 is a view showing an independent HARQ operation for each component carrier, which is related to configuring of an SRBG, according to an embodiment of the present invention.

An HARQ (Hybrid Automatic Repeat reQuest) scheme according to the present invention corresponds to a scheme in which an HARQ operation is performed independently for each component carrier. Namely, the HARQ scheme has a form such that information block of the User Equipment (UE) 10 is divided into transport blocks according to carriers and is transmitted in the form of transport blocks, and then a receiver side transmits/receives whether decoding is successful, for each carrier. As in the present invention, when resources are allocated in the form of configuring an SRBG, resources are allocated based on an SRBG obtained by connecting RBGs. In contrast, transport blocks may first be classified according to carriers, and then each of the classified transport blocks may be transmitted through the relevant carrier. Namely, as shown in FIG. 10, the independent HARQ operation for each carrier may be configured.

Also, in the present invention, in a carrier aggregation configuration using multiple component carriers, use may be made of an example of configuring an extension carrier, which enables the existence of the extension carrier which provides an additional resource by extending another component carrier without having a downlink control channel (PDCCH) within a component carrier. Namely, this configuring of the extension carrier can provide an efficient means which is controlled by control information of a component carrier having a downlink control channel (PDCCH) and provides resource allocation of the extension carrier providing an additional resource.

Also, in the present invention, in the carrier aggregation configuration using multiple component carriers, component carriers may be classified into a compatible carrier and a non-compatible carrier. In this case, a criterion used to classify component carriers into a compatible carrier and a non-compatible carrier corresponds to whether a component carrier is compatible with LTE Rel. 8. The allocation of resources based on an SRBG corresponds to a resource allocation scheme enabling the use of a compatible carrier together with an extension carrier, although it may be applied regardless of whether a component carrier is compatible with LTE Rel. 8, in this classification. Namely, the allocation of resources based on an SRBG has an advantage of enabling the form of making it possible to use already-developed products of the implementation of LTE as it is, by borrowing the existing LTE Rel. 8 specifications almost as it is and by configuring carrier aggregation in the form of adding an extension carrier.

The carrier aggregation in this form has an advantage of reducing cost and time required for a standardization work simultaneously with reducing costs and time for development and verification from the viewpoint of implementation.

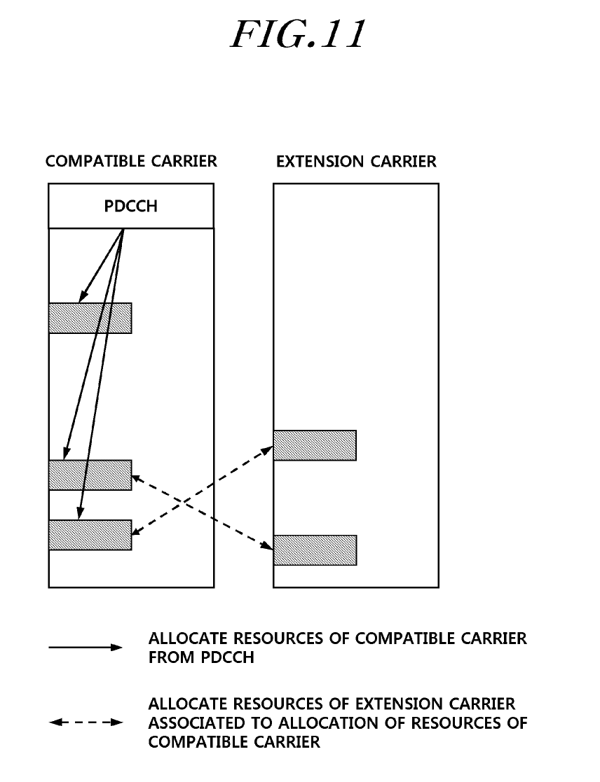

FIG. 11 is a view showing an example of configuring an SRBG in configuring a compatible carrier and an extension carrier in configuring an SRBG according to an embodiment of the present invention.

Referring to FIG. 11, resources of a compatible carrier may be allocated from a PDCCH of the compatible carrier. Also, resources of an extension carrier may be allocated based on control information transmitted through a downlink control channel (PDCCH) of the compatible carrier, to which the extension carrier is associated.

The eNB 20 may configure an SRBG by connecting RBGs existing within one or more component carriers used in the wireless communication system 100, and may perform resource allocation based on information on configuring of the SRBG.

When the SRBG corresponds to an SRBG in downlink, the eNB 20 transmits the information on configuring of the SRBG to the user equipment 10 through a downlink control channel, performs resource allocation for a downlink data channel based on the information on configuring of the SRBG, transmits resource allocation information to the user equipment 10 through the downlink control channel, and transmits data to the user equipment 10 is through the downlink data channel based on the resource allocation information.

When the SRBG corresponds to an SRBG in uplink, the eNB 20 transmits the information on configuring of the SRBG to the user equipment 10 through a downlink control channel, performs resource allocation for an uplink data channel based on the information on configuring of the SRBG, transmits resource allocation information to the user equipment 10 through the downlink control channel, and receives data from the user equipment 10 through the uplink data channel based on the resource allocation information.

The SRBG may include one RBG, or two or more RBGs. Particularly, when the SRBG includes two or more RBGs, the two or more RBGs included in the SRBG may exist within an identical component carrier and may be connected, or may be connected in a state where at least one of the two or more RBGs included in the SRBG exists within another component carrier.

Meanwhile, the user equipment 10 may receive, from the eNB 20, information on configuring of an SRBG configured by connecting RBGs existing within one or more component carriers used in the wireless communication system 100, and may transmit/receive data to/from the eNB 20 according to the received information on configuring of the SRBG.

When the SRBG corresponds to an SRBG in downlink, the user equipment 10 receives data through a downlink data channel and decodes the received data, based on the information on configuring of the SRBG. At this time, when the SRBG corresponds to an SRBG in uplink, the user equipment 10 interprets a downlink control channel based on the information on configuring of the SRBG, and transmits data through an uplink data channel according to a result of the interpretation.

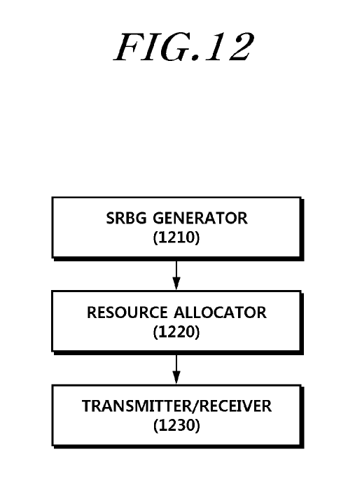

FIG. 12 is a view showing the configuration of an eNB for generating an SRBG and transmitting/receiving data to/from a user equipment according to an embodiment of the present invention.

Referring to FIG. 12, the eNB includes an SRBG generator 1210, a resource allocator 1220, and a transmitter/receiver 1230.

The SRBG generator 1210 selects one or more RBGs from among RBGs included in one or more component carriers and generates an SRBG. The resource allocator 1220 allocates a resource to the user equipment according to configuring of the SRBG. Then, the transmitter/receiver 1230 transmits information on configuring of the generated SRBG to the user equipment, and transmits/receives data to/from the user equipment through the resource allocated by the resource allocator.

More specifically, when the SRBG corresponds to an SRBG in downlink, the transmitter/receiver 1230 receives uplink channel information from the user equipment, and the SRBG generator 1210 generates the SRBG by using one or more of the variability of the uplink channel information and an SNR (Signal-to-Noise Ratio) value or an MCS (Modulation and Coding Scheme) of the uplink channel information among the received uplink channel information. Also, the transmitter/receiver 1230 may receive a report of whether resource allocation is normal, from the user equipment. When the resource allocation is abnormal, the SRBG generator 1210 may reconfigure the SRBG.

The SRBG generator 1210 extracts uplink channel information allocated to the user equipment, and generates the SRBG by using one or more of the variability of the uplink channel information and an SNR (Signal-to-Noise Ratio) value or an MCS (Modulation and Coding Scheme) of the uplink channel information among the extracted uplink channel information.

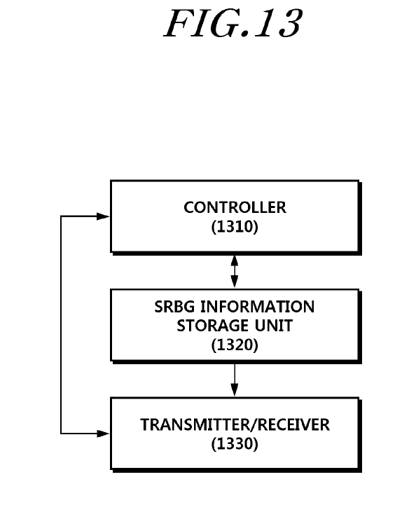

FIG. 13 is a view showing the configuration of a user equipment which is allocated a resource based on an SRBG and transmits/receives data to/from an eNB through the allocated resource, according to an embodiment of the present invention.

Referring to FIG. 13, the user equipment includes a controller 1310, an SRBG information storage unit 1320, and a transmitter/receiver 1330.

The transmitter/receiver 1330 receives information on configuring of an SRBG from the eNB, and transmits/receives data to/from the eNB. The SRBG information storage unit 1320 stores the information on configuring of the SRBG, which has been received from the eNB. Then, the controller 1310 controls the transmitter/receiver 1330 so as to transmit/receive data through a resource allocated based on the information on configuring of the SRBG.

More specifically, the controller 1310 measures uplink channel information, and delivers the measured uplink channel information to the transmitter/receiver, and controls the transmitter/receiver so as to transmit the measured uplink channel information to the eNB. In this case, the controller 1310 may determine whether resource allocation is normal, and may control the transmitter/receiver 1330 so as to transmit a report of whether the resource allocation is normal, to the eNB.

Although the above description is only an illustrative description of the technical idea of the present invention, those having ordinary knowledge in the technical field of the present invention will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the technical idea of the present invention is not limited by the embodiments. The protection scope of the present invention should be construed based on the accompanying claims, and all of the technical ideas included within the scope equivalent to the claims should be construed as being included within the right scope of the present invention.

1. A method for transmitting or receiving data according to a configuring of radio resources by a base station in a wireless communication system, the method comprising:
selecting one or more resource block groups (RBGs) from among RBGs included in one or more component carriers, and generating a set of resource block groups (SRBG);
transmitting information on configuring of the generated SRBG to a user equipment; and
allocating a resource to the user equipment according to configuring of the SRBG, and transmitting data to or receiving data to/from the user equipment through the allocated resource,
wherein the information on configuring of the SRBG includes a component carrier indicator.

2. The method as claimed in claim 1, wherein the method further comprises, if the SRBG corresponds to an SRBG in downlink, before generating of the SRBG, receiving uplink channel information from the user equipment, and
generating of the SRBG comprises generating the SRBG by using one or more of variability of the uplink channel information and a signal-to-noise ratio (SNR) value or a modulation and coding scheme (MCS) of the uplink channel information among the received uplink channel information.

3. The method as claimed in claim 2, further comprising receiving a report of whether resource allocation is normal from the user equipment, and further comprising, if the resource allocation is abnormal, reconfiguring an SRBG.

4. The method as claimed in claim 1, wherein the method further comprises, if the SRBG corresponds to an SRBG in uplink, before generating of the SRBG, extracting uplink channel information allocated to the user equipment, and
generating of the SRBG comprises generating the SRBG by using one or more of variability of the uplink channel information and a signal-to-noise ratio (SNR) value or a modulation and coding scheme (MCS) of the uplink channel information among the extracted uplink channel information.

5. The method as claimed in claim 1, wherein the information on configuring of the generated SRBG includes information indicating a position of an SRBG within a particular component carrier indicated by the component carrier indicator.

6. The method as claimed in claim 5, wherein the information indicating the position of the SRBG includes a number assigned to the SRBG by using an identical component carrier indicator, or a number assigned to the SRBG by using different component carrier indicators.

7. The method as claimed in claim 1, further comprising including information on the allocated resource in a downlink control information (DCI) message, and transmitting the DCI message including the information on the allocated resource.

8. A method for transmitting or receiving data through radio resources by a user equipment in a wireless communication system, the method comprising:
receiving information on configuring of a set of resource block groups (SRBG) from a base station;
receiving a resource allocated by the base station according to configuring of the SRBG; and
transmitting data to or receiving data to/from the base station through one or more resources within the SRBG,
wherein the information on configuring of the SRBG includes a component carrier indicator.

9. The method as claimed in claim 8, further comprising, if the SRBG corresponds to an SRBG in downlink, before receiving of the information on configuring of the SRBG, measuring uplink channel information, and transmitting the measured uplink channel information to the base station.

10. The method as claimed in claim 9, further comprising transmitting a report of whether the resource allocation is normal, to the base station.

11. The method as claimed in claim 8, wherein the information on configuring of the SRBG includes information indicating a position of an SRBG within a particular component carrier indicated by the component carrier indicator.

12. The method as claimed in claim 11, wherein the information indicating the position of the SRBG includes a number assigned to the SRBG by using an identical component carrier indicator, or a number assigned to the SRBG by using different component carrier indicators.

13. The method as claimed in claim 8, further comprising receiving a downlink control information (DCI) message including information on the allocated resource.

14. A base station apparatus for to transmit or receive data according to configuring of radio resources in a wireless communication system, the base station apparatus comprising:
a set of resource block groups (SRBG) generator for selecting one or more resource block groups (RBGs) from among RBGs included in one or more component carriers, and generating a SRBG;
a resource allocator for allocating a resource to a user equipment according to configuring of the SRBG; and
a transmitter/receiver to transmit or to receive transmitting information on configuring of the generated SRBG to the user equipment, and to transmit data to or receive data from the user equipment through the resource allocated by the resource allocator,
wherein the information on configuring of the SRBG includes a component carrier indicator.

15. The base station apparatus as claimed in claim 14, wherein, if the SRBG corresponds to an SRBG in downlink, the transmitter/receiver receives uplink channel information from the user equipment, and the SRBG generator generates the SRBG by using one or more of variability of the uplink channel information and a signal-to-noise ratio (SNR) value or a modulation and coding scheme (MCS) of the uplink channel information among the received uplink channel information.

16. The base station apparatus as claimed in claim 15, wherein the transmitter/receiver receives a report of whether the resource allocation is normal, from the user equipment, and the SRBG generator reconfigures the SRBG when if the resource allocation is abnormal.

17. The base station apparatus as claimed in claim 14, wherein, if the SRBG corresponds to an SRBG in uplink, the SRBG generator extracts uplink channel information allocated to the user equipment, and generates the SRBG by using one or more of variability of the uplink channel information and a signal-to-noise ratio (SNR) value or a modulation and coding scheme (MCS) of the uplink channel information among the extracted uplink channel information.

18. The base station apparatus as claimed in claim 14, wherein the information on configuring of the SRBG includes information indicating a position of an SRBG within a particular component carrier indicated by the component carrier indicator.

19. The base station apparatus as claimed in claim 18, wherein the information indicating the position of the SRBG includes a number assigned to the SRBG by using an identical component carrier indicator, or a number assigned to the SRBG by using different component carrier indicators.

20. The base station apparatus as claimed in claim 18, wherein the transmitter/receiver transmits a downlink control information (DCI) message including information on the allocated resource.

21. A user equipment to transmit or receive data through radio resources in a wireless communication system, the user equipment comprising:
a transmitter/receiver to receiving information on configuring of a set of resource block groups (SRBG) from a base station, and to transmit data to or receive data from the base station;
an SRBG information storage unit to store the information on configuring of the SRBG, which has been received from the base station; and
a controller to control the transmitter/receiver so as to transmit or receive data through a resource allocated based on the information on configuring of the SRBG,
wherein the information on configuring of the SRBG includes a component carrier indicator.

22. The user equipment as claimed in claim 21, wherein, if the SRBG corresponds to an SRBG in downlink, the controller measures uplink channel information, and controls the transmitter/receiver so as to transmit the measured uplink channel information to the base station.

23. The user equipment as claimed in claim 22, wherein the controller determines whether the resource allocation is normal, and controls the transmitter/receiver so as to transmit a report of whether the resource allocation is normal, to the base station.

24. The user equipment as claimed in claim 21, wherein the information on configuring of the SRBG includes information indicating a position of an SRBG within a particular component carrier indicated by the component carrier indicator.

25. The user equipment as claimed in claim 24, wherein the information indicating the position of the SRBG includes a number assigned to the SRBG by using an identical component carrier indicator, or a number assigned to the SRBG by using different component carrier indicators.

26. The user equipment as claimed in claim 21, wherein the transmitter/receiver receives a downlink control information (DCI) message including information on the allocated resource.
